(19) United States
(12) Patent Application Publication
(10) Pub. No.: US 2008/0256807 A1
(43) Pub. Date: Oct. 23, 2008

(54) Ergonomic training utensil

(76) Inventor: Kimberly Maria Kirkup, Bayshore, NY (US)

Correspondence Address: ASHLEY J. WELLS, Attorney, 27 Outlook Circle, Swannanoa, NC, 28778, US

(21) Appl. No.: 12/082,438

(22) Filed: Apr. 12, 2008

Related U.S. Application Data
(60) Provisional application No. 60/923,919, filed on Apr. 18, 2007.

(51) Int. Cl. A47G 21/06; G09B 19/24; A47G 21/02; B26B 3/02; A47G 21/04

(52) U.S. Cl. 30/147; 434/258; 30/322; 30/324; 30/148; 30/149; 30/150; 30/340

(57) ABSTRACT

An ergonomic training utensil for teaching a user to self feed includes a handle and at least one food accommodating means extending from at least one end of the handle. In a first embodiment, the training utensil has an arc shape when viewed from top and bottom and the handle has a center section which has a transverse cross-section which is one of bulbous or lobular. In a second embodiment, the handle is a parallelogram and is one of a rhombus or a rectangle, and has a center section having a transverse cross-section which has an S-shaped. Ergonomic utility is provided by the arc shape of the utensil and by the bulbous or lobular transverse cross-section of the handle of the first embodiment, and by the S-shape of the transverse cross-section of the second embodiment.

### CROSS-REFERENCE TO RELATED APPLICATION

This Application for U.S. Letters Patent claims the benefit of the priority of Provisional Application No. 60/923,919 filed Apr. 18, 2007, the disclosure of which is herein incorporated by reference.

### BACKGROUND OF INVENTION

1. Field of the Invention

The present invention relates to a training utensil for users including human children and adults, and certain animals capable of holding utensils such as primates and, more particularly, to an ergonomic training utensil which speeds the learning process and may be additionally used as a teething device.

2. Description of the Related Art

Implements to facilitate food consumption abound throughout the history of mankind. In modern Western society, such utensils include spoons, forks, and knives of various sizes and shapes. Hand and eye physical coordination and neurological coordination are necessary to feed ourselves using utensils. These are learned skills.

Children need to learn these skills and their teachers are generally their parents. They start with their hands and graduate to spoons and, later, forks and knives. The leap from hands to spoon is generally the most difficult. Once the spoon is mastered, the leap to mastering forks and knives is generally rapid.

The learning process is frequently frustrating for the child during unsuccessful attempts to feed themselves. Certain youngsters with disabilities such as cerebral palsy and certain autistic conditions have particular difficulty learning these skills. Later in life, people who have suffered a stroke, certain neuromuscular injuries, or other coordination-debilitating condition might need to relearn the skills needed to feed them selves. This relearning process can be even more frustrating for an adult who laments the lost skills and is inclined to be embarrassed by spills and mishaps.

Despite the great need, prior art attempts to develop training utensils have not resulted in ergonomic utensils that minimize frustration and speed the learning process.

Accordingly, it is an object of the present invention to provide training utensils which are ergonomic and therefore facilitate successful food procurement so that stress and frustration are reduced and learning expedited.

It is another object of the invention to provide training utensils having shallow contours and transverse guard walls to reduce the amount of food accommodated, as well as optionally having transverse ribs and surface texture to promote retention of the food, and provide an even more successful feeding experience.

It is yet another object of the present invention to provide a contoured training utensil having a natural, more ergonomic fit to the hand that guides the user to a more intuitive understanding of effective ways to hold the utensil.

It is a further object of the invention to provide a training utensil having a teething surface for an infant to chew on which not only facilitates teething but also acclimates the infant to holding the training utensil and thereby promotes an earlier learning experience for feeding them self.

### SUMMARY OF THE INVENTION

These and other objects of the invention are provided by an ergonomic training utensil for teaching a user to self feed which includes a handle and at least one food accommodating means extending from at least one end of the handle. In a first embodiment, the training utensil has an arc shape when viewed from top and bottom and the handle has a center section which has a transverse cross-section which is one of bulbous or lobular. In a second embodiment, the handle is a parallelogram and is one of a rhombus or a rectangle when viewed from the top and bottom, and has a center section having a transverse cross-section which has an S-shaped. Ergonomic utility is provided by the arc shape of the utensil and by the bulbous or lobular transverse cross-section of the handle of the first embodiment, and by the S-shape of the transverse cross-section of the second embodiment.

### BRIEF DESCRIPTION OF THE DRAWING

The present invention is described with reference to the drawing figures listed in the following by way of example but not limitation. Those skilled in the art will appreciate that the scope of the invention is not intended to be limited to the specific forms shown in the figures. Various modifications, substitutions and enhancements may be made to the descriptions set forth herein, without departing from the spirit and scope of the invention.

FIG. 1 is an isometric top view of a training utensil having an arc shape according to a first embodiment of the invention and being shown having a spatula knife with optional surface texture and transverse ribbing on the handle, which is held by the right hand of a user (in phantom) with thumb opposing fingers;

FIG. 2 is an isometric top view of a training utensil having an arc shape according to an alternate of the first embodiment of the invention and having a handle which terminates on opposing ends in a fork-like pronged scoop and a spoon-like solid scoop which both cup upwardly in the same direction, i.e., symmetrically;

FIG. 3 is an isometric top view of an alternate of the embodiment of FIG. 2 in which the pronged scoop and the solid scoop cup in opposite directions, i.e., asymmetrically;

FIG. 4 is a rear view of another alternate of the embodiment of FIG. 2 showing a fluted handle having a plurality of longitudinal flanges which extends on opposing ends into respective solid scoops which both cup upwardly in the same direction;

FIG. 5 is a side view of the training utensil shown in FIG. 4 showing transverse guard walls positioned between the ends of the handle and respective solid scoops and having defined therein a perforation to permit air flow;

FIG. 6 is an isometric partial top view of a training utensil according to a second embodiment of the invention showing a handle which is rectangular, has a center section having a transverse cross-section which has an S-shaped, and extends on opposing ends into respective solid scoops (indicated schematically as cupping in opposite directions), and which is shown held by the right hand of a user (in phantom) in an overhand gripping manner;

FIG. 7 is an isometric top view of a training utensil according to a second embodiment of the invention shown with a handle which is a rhomboid, which has a center section having a transverse cross-section which has an S-shaped, and which extends on opposing ends into respective solid scoops (indicated schematically as cupping in opposite directions, and shown held by the right hand of a user (in phantom) in an overhand gripping manner with the knuckles lying in a plane parallel to the long edges of the handle; and

FIG. 8A shows a transverse cross-section of the center section of a handle according to a first embodiment of the invention which is bulbous;

FIG. 8B shows a transverse cross-section of the center section of a handle according to a first embodiment of the invention which is lobular and has a kidney shape;

FIG. 8C shows a transverse cross-section of the center section of a handle according to a first embodiment of the invention which is lobular and has a three leaf clover shape;

FIG. 8D shows a transverse cross-section of the center section of a handle according to a first embodiment of the invention which is lobular and has a four leaf clover shape;

FIG. 8E shows a transverse cross-section of the center section of a handle according to a first embodiment of the invention which is lobular and has a five petal floral shape;

FIG. 8F shows a transverse cross-section of the center section of a handle according to a first embodiment of the invention which is lobular and has a six petal floral shape; and

FIG. 8G shows a transverse cross-section of the center section of a handle according to the second embodiment of the invention which has an S-shaped.

### DESCRIPTION OF THE INVENTION

Learning how to feed ones self can be one of the most frustrating times for a child or an adult. For a child, the physicality of getting a utensil from an eating platform (dish) to their little mouth requires much physical (hand and eye) coordination and neurological coordination that is still developing and not perfected. Not only is coordination on the vertical axis needed to bring the food from the dish to the height of their mouth, coordination on the horizontal axis is needed to line up the utensil for entry into their mouth which requires development of depth perception. An infant in particular may suffer a lack of confidence in his or her ability to perform the tasks needed.

As a learner develops manual dexterity to grasp objects, they begin by learning to feed them selves using their hands. A child has an advantage at this stage compared to an adult because there is typically no sense of inhibition. This process is simple since, as long as the learner brings up a hand full of food to their mouth, a certain percentage of the food will actually enter their mouth and they have achieved their goal. This stage builds confidence and eventually progresses, as coordination of thumb and the other fingers develops, into a pincher grasp, i.e., to grabbing a single food item with the tips of their thumb and index finger and bringing that morsel to their mouth. This teaches the gross-to-fine motor development of using everyday tools, such as the hands, to cognitively achieve a goal.

The learner then progresses to using a food procuring utensil which is typically a spoon. Literature in this field maintains that an infant's natural inclination is to grasp the handle of a spoon at the distal end opposite the scoop. This is wonderful for developing spatial variation but is generally at the expense of eating success. A higher failure rate translates to frustration and a diminution of motivation to continue when the failure rate is higher than the success rate. The learner needs to be guided to grasp the handle of the spoon closer to the scoop.

This is where the training utensils of the present invention advantageously speeds learning and reduces frustration for children learning—and adults relearning—the process of feeding them selves. The training utensil of this invention is ergonomically friendly, can be grasped more readily by a user who is learning motor skills, and follows the natural arc of the forearm as it articulates about the elbow toward the body. This improves the user's dish to mouth success rate, reduces frustration, and speeds learning. As used herein, the term “user” is intended to include humans of any age, as well as animals capable of holding utensils in their hands or paws, such as primates.

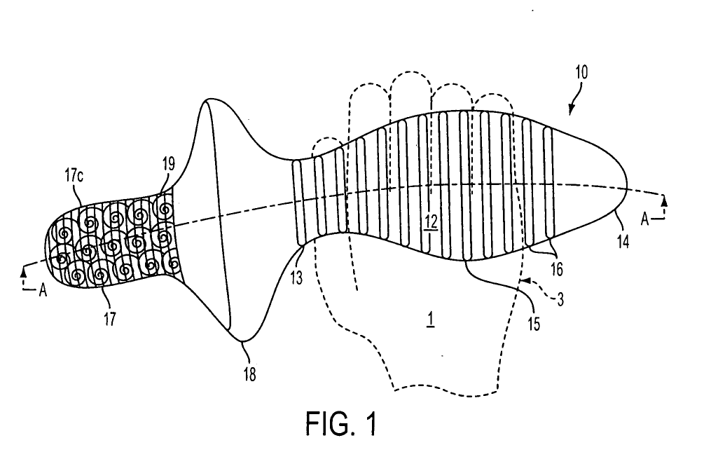

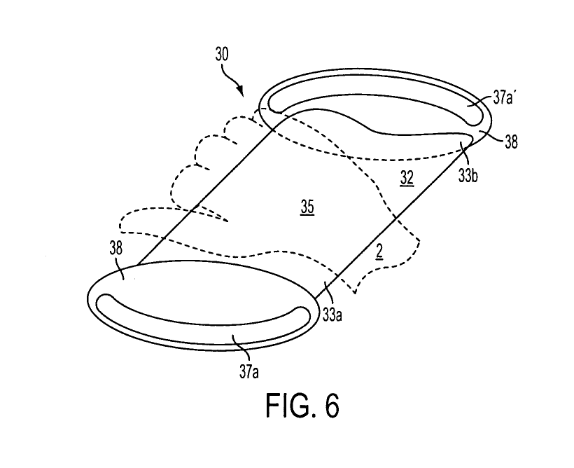

A first embodiment of the training utensil of the invention, hereinafter “arc-shaped”, is shown in FIGS. 1-5, and 8. A second embodiment of the training utensil of the invention, hereinafter “S-shaped”, is shown in FIGS. 6-8.

FIG. 1 is an isometric top view of a training utensil having an arc shape according to a first embodiment of the invention and being shown having a spatula knife with surface texture and transverse ribbing on the handle, which is held by the right hand of a user (shown in phantom) with thumb opposing fingers.

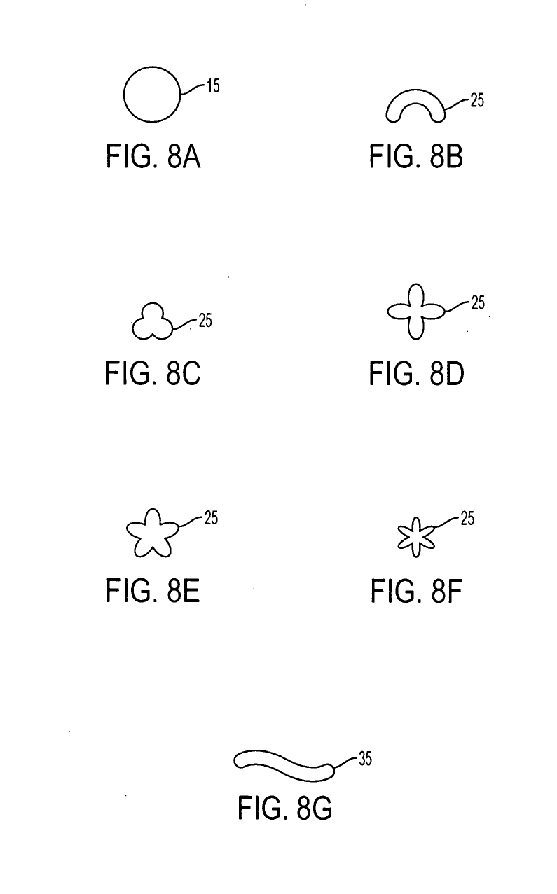

In this first embodiment, an ergonomic training utensil for teaching a user to self feed, comprises a handle including ends and a center section having a transverse cross-section which is one of bulbous (see FIG. 8A) or lobular (see FIG. 8B-8F) with a plurality of lobes; and at least one food accommodating means extending from at least one end of the handle, wherein the ergonomic training utensil has an arc shape when viewed from top and bottom.

The at least one food accommodating means is at least one food accommodating structure and may be selected from among at least one of a solid scoop, a pronged scoop, a spatula blade, and mixtures thereof. Then, the ergonomic training utensil is at least one of a spoon, a fork, a knife, and mixtures thereof, respectively.

In the first embodiment shown in FIG. 1, the ergonomic training utensil has one food accommodating means and one end of the handle is tapered and another end is a terminal end.

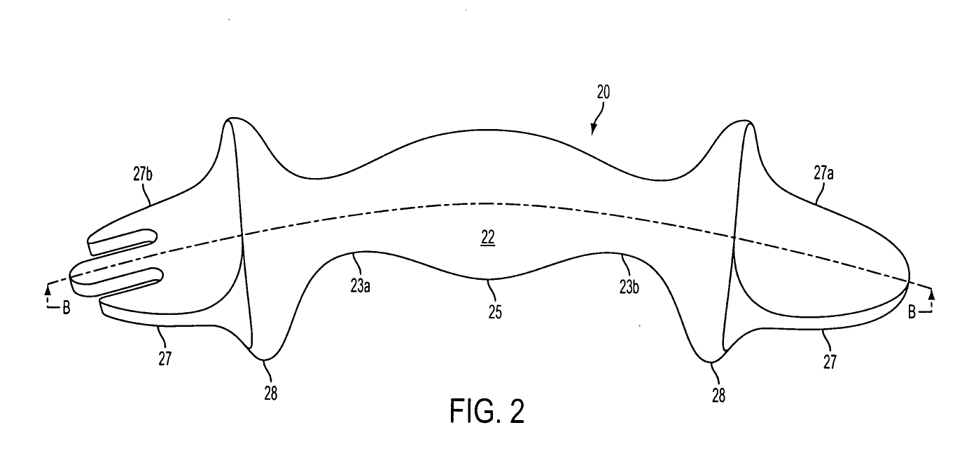

In an alternate of the first embodiment shown in FIGS. 2-4, the ergonomic training utensil has two food accommodating means, the ends of the handle are tapered, and each food accommodating means extends from a respective tapered end of the handle.

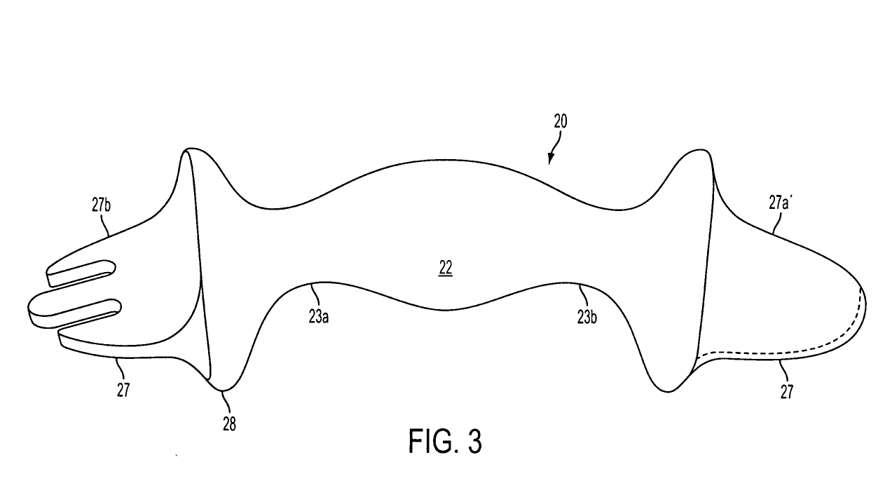

Each of the two of food accommodating means is a food accommodating structure and has a concave orientation when viewed from a side. The concave orientations are one of symmetrical as shown in FIG. 2 or asymmetrical as shown in FIG. 3.

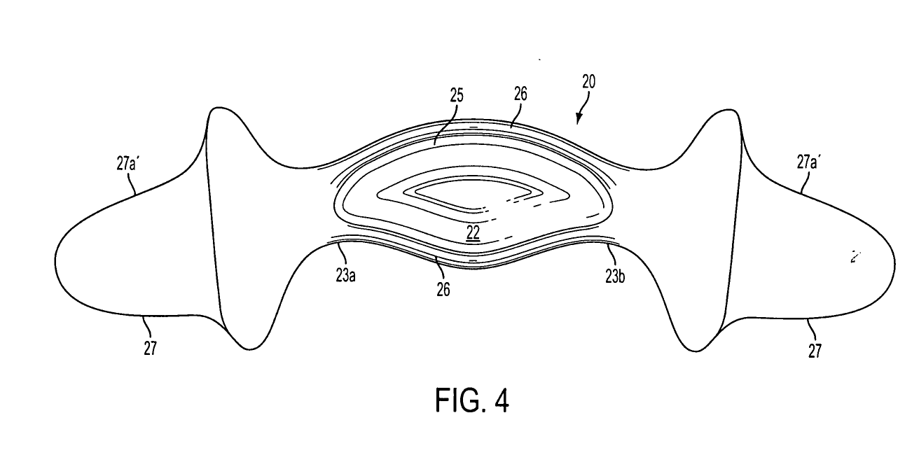

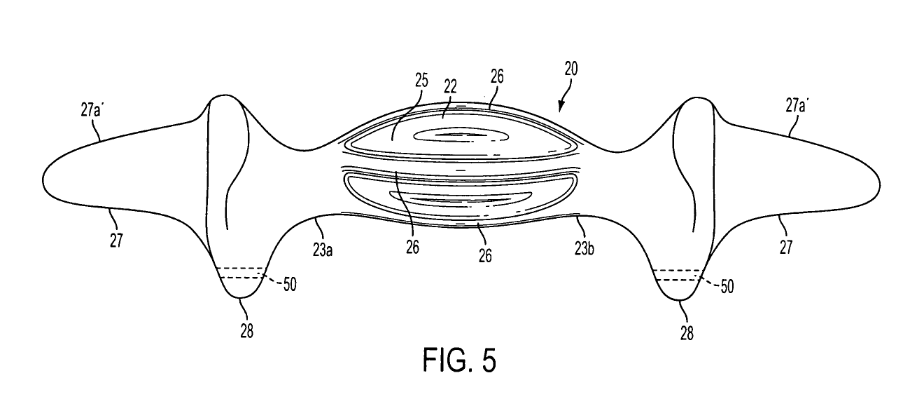

In the variant shown in FIGS. 4 and 5, the handle is fluted for improving gripability in use and comprises a plurality of longitudinal flanges which correspond to the plurality of lobes of the lobular transverse cross-section. The plurality of lobes of the lobular transverse cross-section have a shape selected from among a kidney shape having two lobes, a three leaf clover shape having three lobes, a four leaf clover shape having four lobes, a five petal floral shape having five lobes, and a six petal floral shape having six lobes as shown in FIG. 8 but not exclusively restricted to these lobe orientations as long as it does not deviate from the original intent of the invention.

For improving gripability and food retention in use, at least a portion of at least one of (a) the handle and (b) at least one of the at least one food accommodating means is at least one of (c) ribbed as shown in FIG. 1 and comprises a plurality of circumferential flanges, and (d) textured as shown in FIG. 1. Ribbing and texturing may be used in any embodiment and variant according to this invention.

The ergonomic training utensil may further comprise at least one transverse guard wall provided between at least one end of the handle and the respective at least one food accommodating means for promoting retention of food within the food accommodating means in use and for promoting a stable hand grip in use. The at least one transverse guard wall may have defined therein at least one perforation to permit air flow and promote safe use.

The ergonomic training utensil may be molded of any moldable material, optionally consisting of multiple sections, but is preferably composed of a single molded polymeric material which is one of an elastomer or a rubber. Then, any portion of the ergonomic training utensil may serve as a chewing surface in use to promote teething while also conforming to safety standards for teething articles.

In FIG. 1, training utensil 10 is shown as a food accommodating means 17 which is a food accommodating structure 17 shown as a spatula knife 17c having a blunt end and non-sharp edges. Such a utensil is useful for learning how to butter bread with peanut butter and jelly, for example. Utensil 10 includes a handle 12 having one tapered end 13, one terminal end 14, and an ergonomic shape which is an arc when viewed from top or bottom (see longitudinal centerline, A).

Handle 12 has a center section 15 having a transverse cross-section which is shown as bulbous (see also FIG. 8A). Handle 12 is shown having transverse ribs 16 provided thereon for promoting gripability. Food accommodating means 17 extends from the tapered end 13 of the handle 12 and is shown having texture 19 for promoting food retention. Transverse ribs 16 and texture 19 may be optionally provided on any or all surfaces of any embodiment of an ergonomic training utensil of the invention for promoting gripability and food retention. In FIG. 1, a human right hand 1 is shown in phantom gripping the handle 12 with thumb opposite the fingers but hand orientation for both embodiments can use such an opposable thumb orientation or an in-tandem to other fingers orientation where all fingers cup the handle 12 from the same side. Palm 3 rests on the bulbous center section 15 having a transverse cross-section 15 which is bulbous as shown in FIG. 8A.

The food accommodating means may be one of a solid scoop 17a,27a (see FIG. 2), a pronged scoop 17b,27b (see FIG. 2), a perforated scoop (strainer-like, not shown) or a spatula blade 17c as shown in FIG. 1.

The ergonomic training utensil further comprises a transverse guard wall 18 provided between the tapered end 13 of the handle 12 and the food accommodating means 17. This serves to limit food quantity and promote retention of food within the food accommodating means 17 in use and to promote a stable hand grip in use particularly when the hand chokes up against the transverse guard wall 18. Optionally the guard wall 18 can be provided with at least one perforation 50 (see FIG. 5) to facilitate air passage and promote safe use by infants and others who might otherwise choke if the utensil is pushed too deeply into the user's throat and/or swallowed thereby blocking air passage. The overall shape of guard wall 18 is shown in FIG. 2 as arcuate, but guard wall 18 can have any shape suitable to its function, such as, by way of example but not limitation, semi-circular, circular, oval, lobular, or irregular. For safety reasons, the edges of the guard wall 18, as well as the entire utensil, should be smooth and rounded as shown in the various figures. Additionally, the perpendicular orientation of guard wall 18 with respect to the plane of handle 12 and/or scoop 17a,27a,17b,27b, and blade 17c can have any geometric orientation, e.g., slope or angle, suitable to its function in this invention.

When the ergonomic training utensil 10 has the food accommodating means 17 positioned on the left side of the handle 12 when viewed from the top as shown in FIG. 1, use by a right-handed person is contemplated. When the ergonomic training utensil has the food accommodating means positioned on the right side of the handle when viewed from the top (not shown), use by a left-handed person is contemplated.

A variant of the first embodiment is shown in FIG. 2. FIG. 2 is an isometric top view of a training utensil having an arc shape according to an alternate of the first embodiment of the invention and having a handle which terminates on opposing ends in a fork-like pronged scoop and a spoon-like solid scoop which both cup upwardly in the same direction, i.e., symmetrically.

FIG. 3 is an isometric top view of an alternate of the embodiment of FIG. 2 in which the pronged scoop and the solid scoop cup in opposite directions, i.e., asymmetrically.

In FIG. 2, training utensil 20 is shown having an arc or boomerang shape which follows a longitudinal center line B having an arc shape and includes a handle 22 with first and second tapered ends 23a, 23b. Extending from respective tapered ends 23a, 23b, are food accommodating structures 27 shown as a concave pronged (fork-like) scoop 27b and a concave solid (spoon-like) scoop 27a. Concave scoops 27a, 27b are shown positioned in the same concave orientation with respect to one another, i.e., both cupping upwardly. This symmetrical orientation permits either right- or left-handed use. The arc shape of the handle 22 is shown continuing through the concave scoops when viewed from top and bottom.

The handle 22 is generally grasped close to one of the tapered ends 23a, 23b so that the thumb and forefinger of the user encircles the tapered end chosen while the palm rests on thicker center section 25 of handle 22 (not shown in FIG. 2, see FIG. 1). This serves to stabilize the learner's grip and prevent spills. Center section 25 may have a cross-section 25 having any shape, for example, the lobular shapes shown in FIGS. 8A through 8F by way of example but not limitation. In FIG. 2, the cross-section has a kidney shape giving the cross-section 25 a C-shape as shown in FIG. 8B. This further improves gripability. Transverse guard walls 28 are helpful for retaining food in the concave scoop 27a or 27b chosen to scoop up the food.

FIG. 3 shows training spoon 20 according to a variant of FIG. 2 in an isometric top view. Concave scoops 27a′, 27b are shown positioned in an opposite concave orientation with respect to one another. While the numbering of elements has been generally maintained, the inverted concave solid scoop 27a has been identified as 27a′. This asymmetric orientation of scoops 27a′, 27b permits use by only a right-handed user as shown. In a further variant (not shown), where the concave orientation is flipped to be 27a, 27b′, this orientation permits use by only a left-handed user as shown.

FIG. 4 shows training spoon 20 according to another variant of the first embodiment of the invention in a rear view. The arc shape of the handle 22 is shown continuing through the concave scoops 27a′, 27a′ when viewed from top (not shown) and bottom. FIG. 5 shows this variant in a side view. Training spoon 20 includes a handle 22 having a center section 25, which is fluted and which has a plurality of longitudinal flanges 26, and first and second tapered ends 23a, 23b. Center section 25 has a transverse cross-section 25 which has a lobular shape of a three leaf clover (see FIG. 8C) by way of example but not limitation since any number of lobes may be used (see FIGS. 8B-8G, for example). The plurality of longitudinal flanges 26 promote gripability of handle 22 and advantageously provide at least one of tactile and oral stimulation for teething in use. Concave solid scoops 27a′, 27a′ extend from respective tapered ends 23a, 23b of handle 22. Concave scoops 27a′, 27a′ are shown positioned in the same concave orientation with respect to one another although in a variant (not shown) the concave scoops 27a′, 27a′ may be positioned in an opposite concave orientation with respect to one another.

The handle 22 is generally grasped close to one of the tapered ends 23a, 23b so that the thumb and forefinger of the user encircles the tapered end 23a or 23b chosen while the palm rests on thicker center section 25 of handle 22 (see FIG. 1). This serves to stabilize the learner's grip and prevent spills. Transverse guard walls 28 (see FIG. 5) are helpful for promoting retention of food in the concave scoop 27a chosen to scoop up the food. At least one perforation 50 is preferably defined in each guard wall 28 to permit air flow and provide a safety feature important especially for very young infants who might insert the utensil too deeply into their mouths and block the passage of air.

A second embodiment of the invention is shown in FIGS. 6, 7, and 8G. In this second embodiment, an ergonomic training utensil for teaching a user to self feed, comprises a handle which is a parallelogram and is one of a rhombus or a rectangle, and which has ends and a center section having a transverse cross-section which has an S-shaped; and at least one food accommodating means extending from at least one end of the handle.

The at least one food accommodating means is at least one food accommodating structure and may be selected from among at least one solid scoop, pronged scoop, spatula blade, and mixtures thereof. Then, the ergonomic training utensil is at least one of a spoon, a fork, a knife, and mixtures thereof, respectively.

In one variant of the ergonomic training utensil of the second embodiment, one food accommodating means is provided and one end of the handle is a terminal end.

In another variant of the ergonomic training utensil of the second embodiment, two food accommodating means are provided and each food accommodating means extends from a respective end of the handle. Each of the two food accommodating means are food accommodating structures having a concave orientation when viewed from a side. The concave orientations may be one of symmetrical or asymmetrical.

For improving gripability and food retention in use, at least a portion of at least one of (a) the handle and (b) at least one of the at least one food accommodating means may be at least one of (c) ribbed (see FIG. 1) and comprise a plurality of flanges, and (d) textured (see FIG. 1). Ribbing may be circumferential or transverse although circumferential flanges are exemplified in FIG. 1. Texture may take any form from perforations, to a random surface roughening to regularly spaced dots or flecks by way of example but not limitation.

The ergonomic training utensil may further comprise at least one transverse guard wall provided between at least one end of the handle and the respective at least one food accommodating means for promoting retention of food within the food accommodating means in use and for promoting a stable hand grip in use.

The ergonomic training utensil may be molded from any moldable material, but a polymeric material which is one of an elastomer or a rubber is preferred. Then, any portion of the ergonomic training utensil may serve as a chewing surface in use to promote teething.

When the handle is a rectangle when viewed from top and bottom, and when the center section of the handle includes a concave section which corresponds to the S-shape of the transverse cross-section (see FIG. 8G), then the palm (3) of the user is guided to rest in the concave section of the center section of the handle.

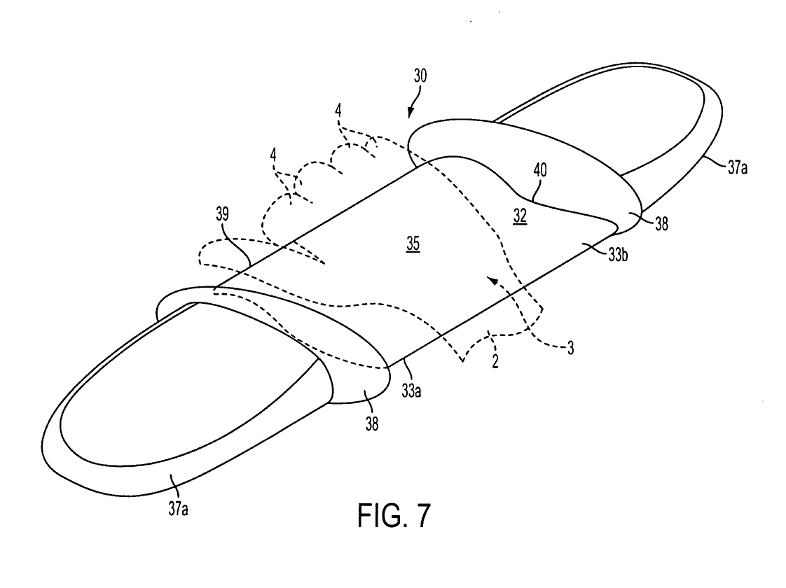

When the handle is a rhombus having long and short edges when viewed from top and bottom (see FIG. 7), when the center section of the handle includes a concave section (see FIG. 7) which corresponds to the S-shape of the transverse cross-section (see FIG. 8G), then the palm of the user rests in the concave section of the center section of the handle and the plane in which the knuckles of the user lie is parallel to the long edges of the handle.

FIG. 6 is a partial isometric view showing ergonomic training utensil 30 having a longitudinal handle 32 which is rectangular when viewed from top and bottom, and which has first and second ends 33a, 33b. Longitudinal handle 32 has a center section 35 having a transverse cross-section 35 which has an S-shape (see FIG. 8G). Food accommodating means 37a, 37a′ (not shown in this view for clarity) extend from each of the first and second ends 33a, 33b of the longitudinal handle 32 and cup upwardly in opposite directions to one another. A right hand 2 is shown in phantom with thumb and fingers positioned on top of handle 32. Palm 3 rests in a concave section 40 of the transverse cross-section 35 of the center section 35 of the handle 32. This serves to urge palm 3 of the user into a desired place on the handle 32 providing a more ergonomic fit. Knuckles 4 lie in a plane which is generally parallel to a long edge 39 of handle 32.

The food accommodating means 37a, 37a′ may be a pair of food accommodating structures selected from among solid scoops 37a, 37a′ (as indicated in this view), pronged scoops 37b (not shown in this view), spatula blades 37c (not shown in this view), and any mixture thereof. Then, the training utensil 30 is therefore one of a spoon, a fork, a knife, and a mixture thereof, respectively. The pair of food accommodating structures 37 may have a concave orientation, and the concave orientation may be symmetrical or asymmetrical.

The ergonomic training utensil 30 may further comprise first and second transverse guard walls 38 provided, respectively, between the first and second ends 33a, 33b of the handle 32 and the food accommodating means 37 for promoting retention of food within the food accommodating means 37 in use and for promoting a stable hand grip in use. This variant may be used in either a right-handed manner or a left-handed manner due to the asymmetrical concave orientation of the food accommodating structures 37.

FIG. 7 is an isometric top view of a variant of the training utensil according to the second embodiment of the invention having a handle which is a rhombus when viewed from top or bottom. Center section 35 has a transverse cross-section 35 which has an S-shaped (see FIG. 8G). Handle 32 extends on opposing ends 33a, 33b into respective solid scoops 37a which cup upwardly in the same concave direction. A right hand 2 is shown in phantom with thumb and fingers positioned on top of handle 32. Palm 3 rests in a concave section 40 of the transverse cross-section 35 of the center section 35 of the handle 32. This serves to urge palm 3 of the user into a desired place on the handle 32 providing a more ergonomic fit. Knuckles 4 lie in a plane which is generally parallel to a long edge 39 of handle 32. In this variant in particular, the rhomboid shape of handle 32 when viewed from top or bottom serves to encourage the user to choke up on the adjacent transverse guard wall 38, to anchor the plane of knuckles 4 in parallel to the longitudinal edge 39 of handle 32, and promote a secure grip and a more ergonomic fit.

For very young infants, the training utensil of the present invention functions more as a teething device and toy which allows the infant a means to ease into utensil holding at an earlier age (imprinting) than what currently available utensils permit given an infant's limited neurological and hand and eye coordination development. The training utensil of the S-shaped second embodiment is particularly conducive to a grasp of thumb and fingers on top as is most natural in early instrument use development. Both the arc-shaped training utensil of the first embodiment and the S-shaped second embodiment permit any type of grasp, including a thumb and fingers on top grasp or the more advanced thumb under, fingers on top grasp. The tapered end of the handle of the arc-shaped training utensil near the food accommodating structure, e.g., scoop, urges the learner's hand to grasp the spoon closer to the scoop which improves dish to mouth success rate, reduces frustration, and speeds learning. The skew of the rhomboid handle variant of the second embodiment of the training utensil functions similarly to urge the learner's hand to grasp the utensil closer to the food accommodating structure, e.g., scoop.

Ergonomically shaping the handle in an arc configuration when viewed from top or bottom and with tapered ends urges the learner to hold the utensil in a certain and more stable way since it intuitively feels right. The arc configuration of the handle follows the natural arc of the hand and forearm as they articulate about the elbow. The thumb and forefinger naturally encircle one tapered end, and the palm rests on the thicker center section of the handle. The hand is thus placed closer to one food accommodation structure, e.g., a concave spoon section, and the training utensil is less likely to roll over. Ergonomic conformation of the handle to the hand of the learner provides for less “give” in the hand positioning of the utensil, which in turn, gives the utensil a more consistent travel path in an arc from dish to mouth. This increases the learner's chance of success, thereby motivating them to continue eating instead of giving up out of frustration. Additionally, the handle or any part of the utensil can have perforations that would increase the ergonomic design or gripability of the handle for an infant or person of compromised dexterity.

Transverse guard walls are optional but advantageously provide an interface between the handle and the food contained in the food accommodation structure in use. This prevents the hand of the learner from slipping forward and prematurely pushing the food off of the utensil.

The food accommodating structure, e.g., a concave scoop, is optionally designed to be somewhat shallow so that the quantity of food is not excessive. The combination of transverse guard walls and a shallow concave food accommodating structure is particularly advantageous for minimizing not only overfilling of the spoon but also minimizing spilling of food during movement from dish to mouth. This is contrary to, commercially available spoons which permit overfilling so that most of the food either gets caught on the outside of the learner's mouth or enters the mouth but the excessive quantity of food increases the chance of choking.

Since the handle is ergonomic and designed to fit into the learner's hand, the training utensil can either be manufactured with dual food accommodating structures, e.g., concave scoop ends, so it can be held by either hand or with a single food accommodating structure as a left or right handed utensil.

The training utensil may be made of any suitable non-toxic material having sufficient strength and hardness. Safety standards require not only a non-toxic material, but also a non-friable, non-shattering, non-splintering material. By way of example but not limitation, suitable materials include natural rubber, a synthetic elastomer or rubber, such as a silicone rubber, a polymeric material having a suitable Shore hardness, for example, a Shore hardness of about 58, such as polytetrafluoroethylene (PTFE), and a metal, for example, sterling silver or stainless steel. The training spoon may be manufactured by any suitable method for the material selected, such as by extrusion, molding, machining or any other suitable method.

While the present invention has been described in conjunction with embodiments and variations thereof, one of ordinary skill after reviewing the foregoing specification will be able to effect various changes, substitutions of equivalents and other alterations without departing from the broad concepts disclosed herein. It is therefore intended that Letters Patent granted hereon be limited only by the definition contained in the appended claims and equivalents thereof.

What is claimed is:

1. An ergonomic training utensil for teaching a user to self feed, comprising:
a handle including ends and a center section having a transverse cross-section which is one of bulbous or lobular with a plurality of lobes; and
at least one food accommodating means extending from at least one end of the handle,
wherein the ergonomic training utensil has an arc shape when viewed from top and bottom.

2. The ergonomic training utensil according to claim 1, wherein the at least one food accommodating means is at least one food accommodating structure, wherein the at least one food accommodating structure is selected from among at least one solid scoop, pronged scoop, spatula blade, and mixtures thereof, and wherein the ergonomic training utensil is at least one of a spoon, a fork, a knife, and mixtures thereof, respectively.

3. The ergonomic training utensil according to claim 2, wherein the ergonomic training utensil has one food accommodating means, and wherein one end of the handle is tapered and another end is a terminal end.

4. The ergonomic training utensil according to claim 2, wherein the ergonomic training utensil has two food accommodating means, wherein the ends of the handle are tapered, and wherein each food accommodating means extends from a respective tapered end of the handle.

5. The ergonomic training utensil according to claim 4, wherein each of the two of food accommodating means is a food accommodating structure and has a concave orientation when viewed from a side, and wherein the concave orientations are one of symmetrical or asymmetrical.

6. The ergonomic training utensil according to claim 1, wherein the handle is fluted for improving gripability in use and comprises a plurality of longitudinal flanges which correspond to the plurality of lobes of the lobular transverse cross-section.

7. The ergonomic training utensil according to claim 6, wherein the plurality of lobes of the lobular transverse cross-section have a shape selected from among a kidney shape having two lobes, a three leaf clover shape having three lobes, a four leaf clover shape having four lobes, a five petal floral shape having five lobes, and a six petal floral shape having six lobes.

8. The ergonomic training utensil according to claim 6, wherein, for improving gripability and food retention in use, at least a portion of at least one of (a) the handle and (b) at least one of the at least one food accommodating means is at least one of (1) ribbed and comprises a plurality of flanges which may be circumferential or transverse, and (2) textured.

9. The ergonomic training utensil according to claim 1, wherein, for improving gripability and food retention in use, at least a portion of at least one of (a) the handle and (b) at least one of the at least one food accommodating means is at least one of (1) ribbed and comprises a plurality of flanges which may be circumferential or transverse, and (2) textured.

10. The ergonomic training utensil according to claim 1, further comprising at least one transverse guard wall provided between at least one end of the hand and the respective at least one food accommodating means for promoting retention of food within the food accommodating means in use and for promoting a stable hand grip in use.

11. The ergonomic training utensil according to claim 10, wherein the at least one transverse guard wall has defined therein at least one perforation to permit air flow.

12. The ergonomic training utensil according to claim 1, wherein the ergonomic training utensil is composed of a polymeric material which is one of an elastomer or a rubber, and wherein any portion of the ergonomic training utensil may serve as a chewing surface in use to promote teething.

13. An ergonomic training utensil for teaching a user to self feed, comprising:
a handle which is a parallelogram and is one of a rhombus or a rectangle, and which has ends and a center section having a transverse cross-section which has an S-shaped; and
at least one food accommodating means extending from at least one end of the handle.

14. The ergonomic training utensil according to claim 13, wherein the at least one food accommodating means is at least one food accommodating structure, wherein the at least one food accommodating structure is selected from among at least one solid scoop, pronged scoop, spatula blade, and mixtures thereof, and wherein the ergonomic training utensil is at least one of a spoon, a fork, a knife, and mixtures thereof, respectively.

15. The ergonomic training utensil according to claim 14, wherein the ergonomic training utensil has one food accommodating means, and wherein one end of the handle a terminal end.

16. The ergonomic training utensil according to claim 14, wherein the ergonomic training utensil has two food accommodating means and wherein each food accommodating means extends from a respective end of the handle.

17. The ergonomic training utensil according to claim 16, wherein each of the two food accommodating means are food accommodating structures having a concave orientation when viewed from a side, and wherein the concave orientations are one of symmetrical or asymmetrical.

18. The ergonomic training utensil according to claim 13, wherein, for improving gripability and food retention in use, at least a portion of at least one of (a) the handle and (b) at least one of the at least one food accommodating means is at least one of (1) ribbed and comprises a plurality of flanges which are circumferential or transverse, and (2) textured.

19. The ergonomic training utensil according to claim 13, further comprising at least one transverse guard wall provided between at least one end of the handle and the respective at least one food accommodating means for promoting retention of food within the food accommodating means in use and for promoting a stable hand grip in use.

20. The ergonomic training utensil according to claim 19, wherein the at least one transverse guard wall has defined therein at least one perforation to permit air flow.

21. The ergonomic training utensil according to claim 13, wherein the ergonomic training utensil is composed of a polymeric material which is one of an elastomer or a rubber, and wherein any portion of the ergonomic training utensil may serve as a chewing surface in use to promote teething.

22. The ergonomic training utensil according to claim 13, wherein the user has a hand having a palm, wherein the handle is a rectangle when viewed from top and bottom, wherein the center section of the handle includes a concave section which corresponds to the S-shape of the transverse cross-section, and wherein the palm of the user rests in the concave section of the center section of the handle.

23. The ergonomic training utensil according to claim 13, wherein the user has a hand having a palm and knuckles which lie in a plane, wherein the handle is a rhombus having long and short edges when viewed from top and bottom, wherein the center section of the handle includes a concave section which corresponds to the S-shape of the transverse cross-section, and wherein the palm of the user rests in the concave section of the center section of the handle and the plane in which the knuckles of the user lie is parallel to the long edges of the handle.
